(19) United States
(12) Patent Application Publication
(10) Pub. No.: US 2025/0030665 A1
(43) Pub. Date: Jan. 23, 2025

(54) GEOLOCATION TO IDENTIFY VIRTUAL PRIVATE NETWORKS

(71) Applicant: MASTERCARD TECHNOLOGIES CANADA ULC, Vancouver (CA)

(72) Inventors: Jonathan McGrandle, Maple Ridge (CA); Kyle Williams, Wentzville, MO (US)

(21) Appl. No.: 18/776,626

(22) Filed: Jul. 18, 2024

Related U.S. Application Data
(60) Provisional application No. 63/514,510, filed on Jul. 19, 2023.

(51) Int. Cl. H04L 9/40

(52) U.S. Cl. CPC H04L 63/0272; H04L 63/107

(57) ABSTRACT

Systems, methods, and non-transitory computer-readable media for identifying electronic communications from a virtual private network (VPN). An VPN/Proxy communication identifier application receiving a request, enriched with location information of the client device, from a client device. Determining a geolocation of the client device based on the location information. Determining a geolocation of an internet protocol (IP) address associated with the client device. Determining a distance between the geolocations of the client device and the IP address. Flagging the request that is received as associated with a virtual private network or a proxy based on the distance that is determined.

### RELATED APPLICATIONS

This application claims priority to U.S. Provisional Patent Application No. 63/514,510, filed on Jul. 19, 2023, the entire contents of which are hereby incorporated by reference.

### FIELD OF THE INVENTION

The present disclosure relates generally to proxy and virtual private network (VPN) detection. More specifically, the present disclosure relates to systems, methods, and non-transitory computer-readable media for identifying electronic communications from a VPN or a proxy server.

### BACKGROUND

A virtual private network (VPN) is a mechanism for creating a secure connection between a computing device and a computer network, or between two networks, using an insecure communication medium (e.g., the public internet). A proxy server is a dedicated computer or a software system running on a computer that acts as an intermediary between an endpoint device, such as a computer, and another server from which a user or client is requesting a service. VPNs and proxies allow users to “mask” their IP address by routing internet traffic through a different server.

VPNs and proxies may be utilized to spoof (i.e., disguising a communication from an unknown source as being from a known, trusted source) their geolocation or to conceal their IP address from the application that is accessed to, for example, access geo-restricted services. Detection of a VPN/proxy is necessary to conform with region-based regulations. For example, a banking application of a banking institution may only be allowed to provide a service to a user located in a specific region. In another example, a media streaming service may only be allowed to offer certain content in a specific region. The requirement may also stem from fraud prevention efforts to identify malicious users that frequently use VPNs/proxies to mask their IP address. The IP address may serve as a semi-unique user identifier and could be used to locate a user.

### SUMMARY

Various embodiments of the present disclosure recognize that challenges exist in the identification of electronic communications received from a VPN/proxy. In some instances, legitimate users of applications often leverage VPNs/proxies as an additional layer of privacy, as such browser and device manufacturers attempt to prevent applications from detecting these services. Historically, companies have tried to detect/bypass VPNs/proxies through a variety of methods, such as, for example, latency analysis, web protocols, open port scanning, IP look-up, blacklisting IP addresses associated with VPNs/proxies, etc.

A VPN/proxy adds additional network hops, which in theory also adds latency. However, latency analysis between a user and an application server is prone to high false positives and high false negatives. Moreover, the latency analysis can also be easily circumvented by fraudsters.

Some web protocols attempt to bypass the VPN/proxy to establish direct communication with a client device that may not be routed through a proxy, which results in the origin of the client device being exposed. However, these web protocols result in high false negatives due to failed direct connections and browsers/devices often block these protocols for privacy reasons.

Open port scanning is based on VPN/proxy servers generally having more open ports than a consumer device would. However, scanning for open ports has high cost, high latency, and low efficacy.

IP lookups rely on a maintained mapping of IP carriers to IP addresses. In some instances, a VPN/proxy will often originate from services that are not used by legitimate users. This methodology has high overhead associated with maintaining a list of IP carriers associated with VPNs/proxies and is also prone to false negatives. In this context, a false positive is incorrectly determining that a user is using a VPN/proxy when in fact the user is not. A false negative is failing to flag a user that is in fact using a VPN/proxy.

Various embodiments of the present disclosure solve the challenges associated with identifying electronic communications from a VPN/proxy by analyzing and comparing a geolocation reported by a device against a geolocation associated with an IP address. In some embodiments, users accessing the internet directly, without a VPN/proxy, will have a small delta between the geolocation reported by the device and the geolocation associated with the IP address. In other embodiments, users accessing the internet with a VPN/proxy will have a large delta between the geolocation reported by the device and the geolocation associated with the IP address.

Another benefit of the embodiments described herein is automatic labelling of IP addresses associated with potential use of a VPN/proxy. The labelling may then be used to help reduce fraudulent activities and comply with region-based regulations.

One embodiment described herein is a system for identifying electronic communications from at least one of a virtual private network or proxy. The system includes a client device including a first electronic processor and a first memory, and a server including a second electronic processor and a second memory. The second memory including an VPN/Proxy communication identifier application. The VPN/Proxy communication identifier application receiving a request from the client device. The request is enriched with location information of the client device. The VPN/Proxy communication identifier application determining a geolocation of the client device based on the location information of the request that is enriched. The VPN/Proxy communication identifier application determining a geolocation of an internet protocol (IP) address associated with the client device. The VPN/Proxy communication identifier application determining a distance between the geolocation of the client device and the geolocation of the IP address. The VPN/Proxy communication identifier application flagging the request that is received as associated with a virtual private network based on the distance that is determined.

Another embodiment described herein is a method. The method includes receiving, with an electronic processor, a request from a client device. The request is enriched with location information of the client device. The method includes determining, with the electronic processor, a geolocation of the client device based on the location information of the request that is enriched. The method includes determining, with the electronic processor, a geolocation of an internet protocol (IP) address associated with the client device. The method includes determining, with the electronic processor, a distance between the geolocation of the client device and the geolocation of the IP address. The method includes flagging, with the electronic processor, the request that is received as associated with a virtual private network or a proxy based on the distance that is determined.

Yet another embodiment described herein is a non-transitory computer-readable medium comprising instructions that, when executed by an electronic processor, cause the electronic processor to perform a set of operations. The set of operations includes receiving a request from a client device. The request is enriched with location information of the client device. The set of operations includes determining a geolocation of the client device based on the location information of the request that is enriched. The set of operations includes determining a geolocation of an internet protocol (IP) address associated with the client device. The set of operations includes determining a distance between the geolocation of the client device and the geolocation of the IP address. The set of operations includes flagging the request that is received as associated with a virtual private network or a proxy based on the distance that is determined.

Other aspects of the invention will become apparent by consideration of the detailed description and accompanying drawings.

### BRIEF DESCRIPTION OF THE DRAWINGS

FIG. 1 is a block diagram illustrating an example system for identifying electronic communications from VPNs and proxies, in accordance with various aspects of the present disclosure.

FIG. 2 schematically illustrates an example communication or data flow for identifying the electronic communications from the VPNs and the proxies, in accordance with various aspects of the present disclosure.

FIG. 3 is a flow diagram illustrating an example process for identifying the electronic communications from the VPNs and the proxies, in accordance with various aspects of the present disclosure.

FIG. 4 is a flow diagram illustrating a second example process for identifying the electronic communications from the VPNs and the proxies, in accordance with various aspects of the present disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

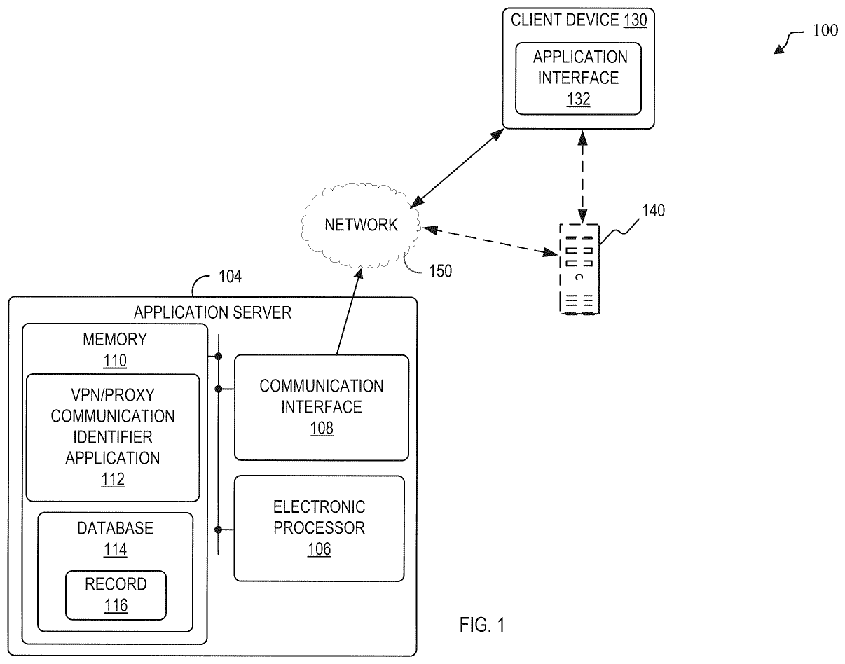

FIG. 1 is a block diagram illustrating an example system for identifying electronic communications from VPNs and proxies, in accordance with various aspects of the present disclosure. In the example of FIG. 1, the system 100 includes an application server 104, a client device 130, a server 140, and a network 150. In an embodiment, the system 100 includes the application server 104, the client device 130, and the server 140, all interconnected over the network 150. The network 150 can be, for example, a local area network (LAN), a telecommunications network, a wide area network (WAN), such as the Internet, or any combination thereof, and include wired, wireless, or fiber optic connections. In general, network 150 can be any combination of connections and protocols, which will support communications between the application server 104, the client device 130, and the server 140, in accordance with embodiments of the present invention.

The application server 104 may be owned by, or operated by or on behalf of, an administrator. The application server 104 includes an electronic processor 106, a communication interface 108, and a memory 110. The electronic processor 106 is communicatively coupled to the communication interface 108 and the memory 110. The electronic processor 106 is a microprocessor or another suitable processing device. The communication interface 108 may be implemented as one or both of a wired network interface and a wireless network interface. The memory 110 is one or more of volatile memory (e.g., RAM) and non-volatile memory (e.g., ROM, FLASH, magnetic media, optical media, et cetera). In some examples, the memory 110 is also a non-transitory computer-readable medium. Although shown within the application server 104, memory 110 may be, at least in part, implemented as network storage that is external to the application server 104 and accessed via the communication interface 108. For example, all or part of memory 110 may be housed on the “cloud.”

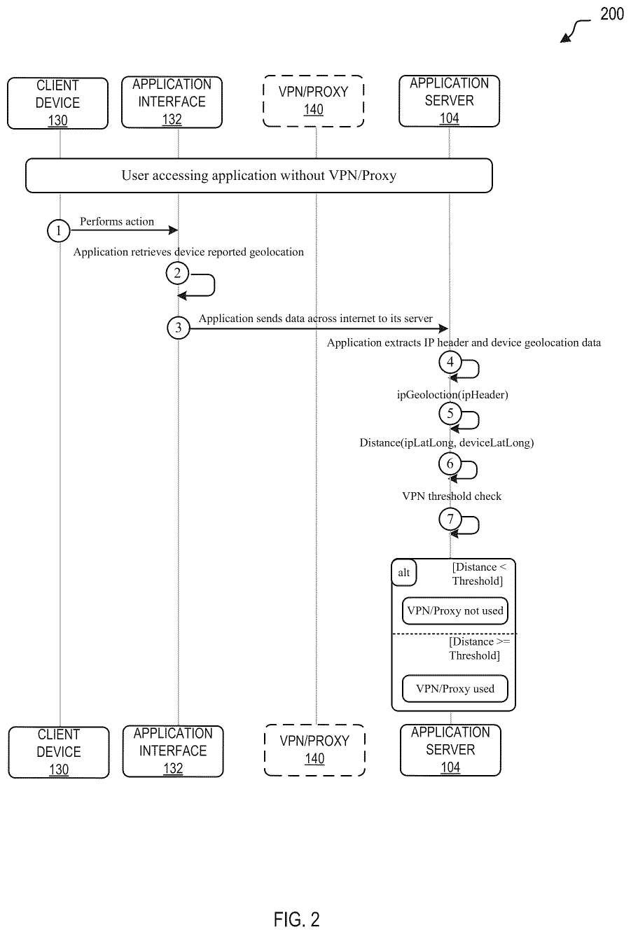

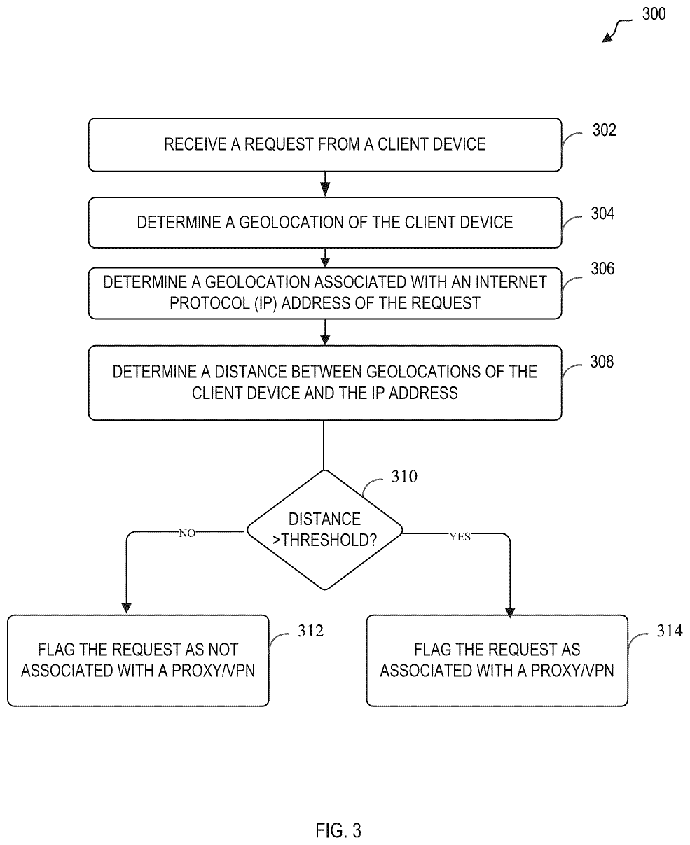

A VPN/Proxy communication identifier application 112 may be stored within a transitory or non-transitory portion of the memory 110. VPN/Proxy communication identifier application 112 includes machine readable instructions that are executed by the electronic processor 106 to perform the functionality of the application server 104 as described below with respect to FIGS. 2-3.

The memory 110 may include a database 114 for storing a record 116 that includes information about individual client device(s) 130. The database 114 may be an RDF database, i.e., employ the Resource Description Framework. Alternatively, the database 114 may be another suitable database with features similar to the features of the Resource Description Framework, and various non-SQL databases, knowledge graphs, etc. The database 114 may include a plurality of records 116 (also referred to herein as a “data pod” or “data store”). Each record 116 may be associated with and contain personal information about one individual. For example, in the illustrated embodiment, the record 116 may be associated with the individual associated with the client device 130, and other N records may be respectively associated with one of N other individuals (not expressly shown in FIG. 1). The record 116 may also include data associated with device identifiers, device reputation, and/or geolocation information.

The client device 130 may be web-compatible mobile computer, such as a laptop, a tablet, a smart phone, or other suitable computing device. Alternately, or in addition, the client device 130 may be a desktop computer. The client device 130 includes an electronic processor in communication with memory. The electronic processor is a microprocessor or another suitable processing device, the memory is one or more of volatile memory and non-volatile memory, and the communication interface may be a wireless or wired network interface.

The client device 130 also includes an application interface 132. The application interface 132 is an application, which contains software instructions implemented by the electronic processor of the client device 130 to perform the functions of the client device 130 as described herein, is stored within a transitory or a non-transitory portion of the memory. The application may have a graphical user interface that facilitates interaction between a user and the client device 130. For example, the application interface 132 is a front-end application of the application server 104.

The client device 130 may communicate with the application server 104 over the network 150. The network 150 is preferably (but not necessarily) a wide area network, such as the Internet. In some examples, the client device 130 may directly communicate with the application server 104. In other examples, the client device 130 may indirectly communicate with the application server 104 over network 150 and the server 140.

The server 140 may be a server computer or a web-compatible mobile computer, such as a laptop, a tablet, a smart phone, or other suitable computing device. Alternately, or in addition, the server 140 may be a desktop computer. The server 140 includes an electronic processor in communication with memory. The electronic processor is a microprocessor or another suitable processing device, the memory is one or more of volatile memory and non-volatile memory, and the communication interface may be a wireless or wired network interface.

An application, which contains software instructions implemented by the electronic processor of the server 140 to perform the functions of the server 140 as described herein, is stored within a transitory or a non-transitory portion of the memory. In some embodiments, the server 140 is a virtual private network (VPN) server that utilizes the application to create a secure connection (e.g., a private tunnel) between a computing device and a computer network, or between two networks, using an insecure communication medium such as the public Internet and provide. In other embodiments, the server 140 is a proxy server that utilizes the application to act as an intermediary between a client requesting a resource and the server providing that resource.

The server 140 may communicate with the application server 104 over the network 150. The network 150 is preferably (but not necessarily) a wide area network, such as the Internet. In some examples, the server 140 may directly communicate with the application server 104 and/or the client device 130. In other examples, the server 140 may indirectly communicate with the application server 104 over network 150.

The application server 104 may likewise communicate with partner devices other than the client device 130. The workings of the application server 104, the client device 130, and the server 140 will now be described in additional detail with respect to FIGS. 2-3.

FIG. 2 is a flow diagram illustrating an example communication or data flow for identifying the electronic communications from the VPNs and the proxies, in accordance with various aspects of the present disclosure. In the example of FIG. 2, a communication environment 200 includes the client device 130, the application interface 132, the server 140, and the application server 104. The communication environment 200 includes a set of signals transmitted in the process of a user attempting to access an application hosted on the application server 104. In some embodiments, the client device 130 may attempt to access the application server 104 through the user of a VPN and/or proxy. In other embodiments, the client device 130 may attempt to access the application server 104 directly via the network 150 (not shown).

In an embodiment, the user performs an action and the client device 130 uses the application interface to generate a request associated with the action of the user (at operation 1). For example, the request is a Hypertext Transfer Protocol (HTTP) request that includes a header, which includes an internet protocol (IP) address associated with the HTTP request. In some implementations, the IP address is associated with a defined geographic area, such as, for example, a country, state, city, region, zip code, registering organization, phone number prefix, time zone, or the like, a set of geographic coordinates, or a combination thereof. The client device 130 transmits the request to the application server 104.

In an embodiment, the application interface 132 retrieves geolocation information associated with the client device 130 and transmits the geolocation information to the application server 104 (at operation 2). For example, a user of the client device 130 grants the application interface 132 permission to access geographic data and information (e.g., global positioning system (GPS) coordinates) utilized by location services of the client device 130. The application interface 132 sends the geographic data and information to the application server 104 to determine a location of the client device 130. In some implementations, the geographic data and information includes a Global Systems for Mobile communications (GSM) Cell ID (CID) that the application interface 132 transmits to the application server 104. The CID is a generally unique number used to identify each base transceiver station (BTS) or sector of a BTS within a location area code if not within a GSM network. The application server 104 can determine a location of the client device 130 based on the location of the BTS in a GSM network. In other implementations, the application server 104 can determine a location of the client device 130 based the geographic data and information, which includes a service set identifier (SSID) of a WLAN the client device 130 utilized. In another example, the client device 130 reports a geolocation to the application interface 132.

In an embodiment, the application interface 132 transmits the geolocation of the client device 130 and the request associated with the action of the user to the application server 104 (at operation 3). In some implementations, the application server 104 receives the request from the client device 130 and transmits an indication to the application interface 132 that causes the application interface to retrieve the geolocation information associated with the client device 130. In other implementations, in response to generating the request, the application interface 132 retrieves the geolocation information associated with the client device 130. In some embodiments, the application interface 132 retrieves the geolocation information using a location services application programming interface (API) of the client device 130. For example, the application interface 132 determines a geolocation of the client device 130 based on geolocation information provided by one or more location service API of the client device 130 that the user permits the application server 104 to access. In this example, the geolocation information may include Global Positioning System (GPS) coordinates and/or locations associated with Wi-Fi networks, nearby cellular towers, or the like. In some embodiments, the application interface 132 enriches the request associated with the user action by appending the geolocation information that is retrieved from the client device 130 to the request.

In an embodiment, the application server 104 extracts the IP address from the header of the request and geolocation data (e.g., latitude and longitude coordinates) from the geolocation information that the application interface 132 transmits to the application server 104 (at operation 4). In some implementations, the application server 104 determines the geolocation data of the client device 130 based on a location from a cell tower, Wi-Fi network, or the like. In other implementations, the application server 104 determines a set of geographic coordinates for the client device 130 from multiple sources of geolocation information, such as, for example a GPS module, LAN network, WLAN network, cellular networks, and the like. For example, the application server 104 determines a set of geographic coordinates from GPS information, a set of geographic coordinates from cellular tower information associated with the client device 130, and a set of geographic coordinates from Wi-Fi networks. In this example, the application server 104 can aggregate the sets of geographic coordinates to determine the geolocation data of the client device 130. The accuracy of the physical location of the client device 130 may vary depending on the source of the geolocation information. For example, a geolocation of the client device 130 derived from a GPS module of the client device 130 may be more accurate than a geolocation of the client device 130 derived from a connection (e.g., ping) with a cell tower.

In an embodiment, the application server 104 determines a geolocation associated with the IP address extracted from the header of the request (at operation 5). For example, the application server 104 determines geolocation of the IP address extracted from the header by performing a geo-IP lookup using the IP address from the header of the request by searching a mapping database that include a collection of IP addresses mapped to locations.

In an embodiment, the application server 104 determines difference in distance between a geolocation associated with the request of the client device 130 and a geolocation of the client device 130 (at operation 6). In some implementations, the application server 104 performs a distance calculation between the geolocation of the client device 130 and the geolocation of the IP address associated with the requests. For example, the application server 104 determines difference in distance (e.g., miles) between a set of geographic coordinates (e.g., a latitude and longitude) of the client device 130 and a set of geographic coordinates of the IP address that is extracted from the request.

In an embodiment, the application server 104 determines whether a communication of the client device 130 is from a VPN/proxy based on a difference in distance (at operation 7). The application server 104 compares a difference in distance of a geolocation of the client device 130 and the IP address to a distance threshold value. In some instances, the distance difference exceeds the distance threshold value and the application server 104 determines that the client device 130 is using the server 140. In these instances, the application server 104 flags the record 116 associated with the IP address as using a VPN/proxy server. In other instances, the distance difference is within the distance threshold value and the application server 104 determines that the client device 130 is not using the server 140. In these instances, the application server 104 flags the record 116 associated with the IP address as not using a VPN/proxy server.

In some embodiments, the application server 104 defines a distance threshold for the client device 130. The application server 104 can set the distance threshold based on one or more factors (e.g., geolocation information source, reputation of user [e.g., prior valid transactions at certain distance from known location of the user]). In some implementations, the application server 104 can set one or more distance thresholds based on the one or more factors. For example, the application server 104 can set a larger threshold distance when the geolocation information is associated with a cellular tower as compared to when the geolocation information is associated with a Wi-Fi network. In some embodiments, the application server 104 defines the distance threshold based on a tolerance of an application for false-positives and false-negatives.

FIG. 3 is a flow diagram illustrating an example process 300 for identifying the electronic communications from the VPNs and the proxies, in accordance with various aspects of the present disclosure. In the example of FIG. 3, the process 300 is described as performed by the electronic processor 106 in a sequential flow, however, some of the process 300 may also be performed in parallel.

In the process 300, the electronic processor 106 receives a request from a client device (at block 302). For example, the VPN/Proxy communication identifier application 112 receives a request from the client device 130. The application interface 132 retrieves location information of the client device 130. In this example, the application interface 132 enriches the request with location information of the client device 130. The location information includes geographic data related to a physical location of the client device 130. In some instances, the application server 104 receives the request from client device 130 over the network 150. In other instances, the application server 104 receives the request via the network 150 from the server 140, which receives the request from the client device 130.

In the process 300, the electronic processor 106 determines a geolocation of the client device (at block 304). For example, the electronic processor 106 executes the VPN/Proxy communication identifier application 112 to receive geolocation information associated with the client device 130 via the application interface 132. The electronic processor 106 executes the VPN/Proxy communication identifier application 112 to determine the geolocation data corresponding to a location of the client device 130 using the geolocation information that is received.

In the process 300, the electronic processor 106 determines a geolocation associated with an IP address of the request (at block 306). For example, the electronic processor 106 executes the VPN/Proxy communication identifier application 112 to extract an IP address from a header of the request that is received. The electronic processor 106 executes the VPN/Proxy communication identifier application 112 to determine geolocation data corresponding to a location associated with the IP address that is extracted by performing a look-up method discussed above according to various embodiments of the present disclosure.

In the process 300, the electronic processor 106 determines a distance between geolocations of the client device and the IP address (at block 308). For example, the VPN/Proxy communication identifier application 112 determines a first set of geographic coordinates for a geolocation of the client device 130 and a second set of geographic coordinates for the geolocation of the IP address that is extracted. The VPN/Proxy communication identifier application 112 determines a difference in distance between the first set of geographic coordinates and the second set of geographic coordinates.

In the process 300, the electronic processor 106 determines whether the distance that is determined exceeds a threshold (at block 310). For example, the VPN/Proxy communication identifier application 112 compares the difference in distance that is determined to a threshold distance value. When a value associated with the difference in distance that is determined is greater than (e.g., exceeds) the threshold distance value, the VPN/Proxy communication identifier application 112 determines that the location of the IP address is inconsistent with the location of the client device 130. When a value associated with the difference in distance that is determined is less than or equal to (e.g., within) the threshold distance value, the VPN/Proxy communication identifier application 112 determines that the location of the IP address is consistent with the location of the client device 130. In some instance, the threshold distance value originates from the first set of geographic coordinates that is determined for the client device 130. In some embodiments, the VPN/Proxy communication identifier application 112 defines and/or modifies the threshold distance value based on a source of the location information for the client device 130.

In the process 300, the electronic processor 106 flags the request as not associated with a proxy/VPN (at block 312). For example, when the VPN/Proxy communication identifier application 112 determines that the IP address that is extracted from the header of the request is consistent (e.g., status) with the location of the client device 130. The VPN/Proxy communication identifier application 112 appends a label to the request based on the status. In some implementations, the VPN/Proxy communication identifier application 112 modifies the record 116 associated with IP address to reflect the status that is determined.

In the process 300, the electronic processor 106 flags the request as associated a proxy/VPN (at block 314). For example, when the VPN/Proxy communication identifier application 112 determines that the IP address that is extracted is inconsistent (e.g., status) with the location of the client device 130. The VPN/Proxy communication identifier application 112 appends a label to the request based on the status. In some implementations, the VPN/Proxy communication identifier application 112 modifies the record 116 associated with IP address to reflect the status that is determined. In some implementations, the record 116 that is modified or the label that is appended to the request may be utilized to prevent fraudulent activities related to location spoofing. In some embodiments, the electronic processor 106 denies the request that is received from the client device 130. The electronic processor 106 may transmit a response indication to the client 130 that includes a status, such as, for example, denial, flagged status, rejected request, request processing failure, or the like of the request that is received from the client device 130.

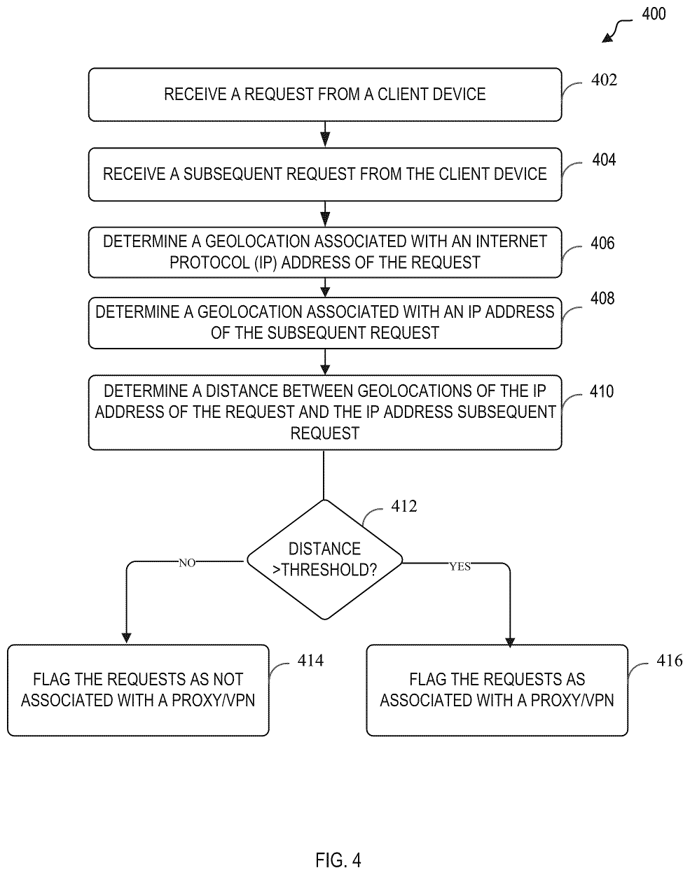

FIG. 4 is a flow diagram illustrating a second example process 400 for identifying the electronic communications from the VPNs and the proxies, in accordance with various aspects of the present disclosure. In the example of FIG. 4, the process 400 is described as performed by the electronic processor 106 in a sequential flow, however, some of the process 400 may also be performed in parallel.

In the process 400, the electronic processor 106 receives a first request from a client device (at block 402). For example, the VPN/Proxy communication identifier application 112 receives a first request of the client device 130. In some instances, the application server 104 receives the first request from client device 130 over the network 150. In other instances, the application server 104 receives the first request via the network 150 from the server 140, which receives the first request from the client device 130.

In the process 400, the electronic processor 106 receives a subsequent request of the client device (at block 404). For example, the VPN/Proxy communication identifier application 112 receives a subsequent request of the client device 130 after receiving a first request of the client device 130. In some instances, the application server 104 receives the subsequent request from client device 130 over the network 150. In other instances, the application server 104 receives the subsequent request via the network 150 from the server 140, which receives the subsequent request from the client device 130.

In the process 400, the electronic processor 106 determines a geolocation associated with an IP address of the first request (at block 406). For example, the electronic processor 106 executes the VPN/Proxy communication identifier application 112 to extract an IP address from a header of a first request that is received. The electronic processor 106 executes the VPN/Proxy communication identifier application 112 to determine geolocation data corresponding to a location associated with the IP address that is extracted by performing a look-up method discussed above according to various embodiments of the present disclosure.

In the process 400, the electronic processor 106 determines a geolocation associated with an IP address of the subsequent request (at block 408). For example, the electronic processor 106 executes the VPN/Proxy communication identifier application 112 to extract an IP address from a header of a subsequent request that is received. The electronic processor 106 executes the VPN/Proxy communication identifier application 112 to determine geolocation data corresponding to a location associated with the IP address that is extracted by performing a look-up method discussed above according to various embodiments of the present disclosure. In some embodiments, the electronic processor 106 determines a geolocation associated with an IP address of the subsequent request when the subsequent request is received within a defined timeframe (e.g., seconds, minutes, hours, days) of receiving the first request.

In the process 400, the electronic processor 106 determines a distance between geolocations of the IP address of the first request and the IP address of the subsequent request (at block 410). For example, the VPN/Proxy communication identifier application 112 determines a first set of geographic coordinates for a geolocation of an IP address of a first request and a second set of geographic coordinates for the geolocation of an IP address of the subsequent request. The VPN/Proxy communication identifier application 112 determines a difference in distance between the first set of geographic coordinates and the second set of geographic coordinates.

In the process 400, the electronic processor 106 determines whether the distance that is determined for the geolocations of the IP address of the first request and the IP address of the subsequent request exceeds a threshold (at decision block 412). For example, the VPN/Proxy communication identifier application 112 compares the difference in distance that is determined for the geolocations of the IP address of the first request and the IP address of the subsequent request to a threshold distance value. When a value associated with the difference in distance that is determined is greater than (e.g., exceeds) the threshold distance value, the VPN/Proxy communication identifier application 112 determines that a location of the IP address of the subsequent request is inconsistent with a location of the IP address of the first request. When a value associated with the difference in distance that is determined is less than or equal to (e.g., within) the threshold distance value, the VPN/Proxy communication identifier application 112 determines that a location of the IP address of the subsequent request is consistent with the location of the IP address of the first request. In some instances, the threshold distance value originates from the first set of geographic coordinates of the IP address of the first request. In some embodiments, the VPN/Proxy communication identifier application 112 defines and/or modifies the threshold distance value based on a source of the location information for the client device 130. In some embodiments, the VPN/Proxy communication identifier application 112 defines and/or modifies the threshold distance value based on the defined timeframe between receiving the first request and the subsequent request. In some implementations, the VPN/Proxy communication identifier application 112 modifies the threshold distance value in proportion to the timeframe between receiving the first request and the subsequent request, such that the VPN/Proxy communication identifier application 112 can flag requests of the client device 130 with different IP addresses associated with unrealistic distances, e.g., locations, received in a certain timeframe as anomalies. For example, the VPN/Proxy communication identifier application 112 may set a threshold distance value (e.g., one hundred miles) when the defined timeframe is one hour. In another example, the VPN/Proxy communication identifier application 112 may set a threshold distance value (e.g., one mile) when the defined timeframe is one second.

In the process 400, the electronic processor 106 flags the requests as not associated with a proxy/VPN (at block 414). For example, when the VPN/Proxy communication identifier application 112 determines that the location of the IP address that is extracted from the header of the subsequent request is consistent (e.g., status) with the location of the IP address that is extracted from the header of the first request (“NO” at decision block 412), the VPN/Proxy communication identifier application 112 appends a label to the requests as not associated with a proxy/VPN (at block 414). In some implementations, the VPN/Proxy communication identifier application 112 modifies the record 116 associated with IP address to reflect the status that is determined.

In the process 400, the electronic processor 106 flags the requests as associated a proxy/VPN (at block 416). For example, when the VPN/Proxy communication identifier application 112 determines that the location of the IP addresses that is extracted from the header of the subsequent request is inconsistent (e.g., status) with the location of the IP address that is extracted from the header of the first request (“YES” at decision block 412), the VPN/Proxy communication identifier application 112 appends a label to the requests as associated with a proxy/VPN.

In some implementations, the VPN/Proxy communication identifier application 112 modifies the record 116 associated with IP addresses to reflect the status that is determined. In some implementations, the record 116 that is modified or the label that is appended to the requests may be utilized to prevent fraudulent activities related to location spoofing. In some embodiments, the electronic processor 106 denies the requests that are received from the client device 130. The electronic processor 106 may transmit a response indication to the client 130 that includes a status, such as, for example, denial, flagged status, rejected request, request processing failure, or the like of the request that is received from the client device 130. In some embodiments, the VPN/Proxy communication identifier application 112 flags the client device 130.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It should thus be noted that the matter contained in the above description or shown in the accompanying drawings is to be interpreted as illustrative and not in a limiting sense.

What is claimed is:

1. A system for identifying electronic communications from at least one of a virtual private network or proxy, the system comprising:
a client device including a first electronic processor and a first memory; and
a server including a second electronic processor and a second memory including a VPN/Proxy communication identifier application, the second electronic processor configured to:
receive, with the VPN/Proxy communication identifier application, a request from the client device, wherein the request is enriched with location information of the client device,
determine, with the VPN/Proxy communication identifier application, a geolocation of the client device based on the location information of the request that is enriched,
determine, with the VPN/Proxy communication identifier application, a geolocation of an internet protocol (IP) address associated with the client device,
determine, with the VPN/Proxy communication identifier application, a distance between the geolocation of the client device and the geolocation of the IP address, and
flag, with the VPN/Proxy communication identifier application, the request that is received as associated with a virtual private network based on the distance that is determined.

2. The system of claim 1, wherein the second electronic processor is further configured to
define, with the VPN/Proxy communication identifier application, a threshold based on a source of the location information for the client device, wherein the location information includes geographic data related to a physical location of the client device.

3. The system of claim 1, wherein, to determine, with the VPN/Proxy communication identifier application, the geolocation of the IP address, the second electronic processor is further configured to
extract the IP address from the request, and
identify a location associated with the IP address that is extracted.

4. The system of claim 1, wherein, to determine, with the VPN/Proxy communication identifier application, the distance between the geolocation of the client device and the geolocation of the IP address, the second electronic processor is further configured to
determine a first geographic coordinate for the geolocation of the client device and a second geographic coordinate for the geolocation of the IP address, and
determine a difference in distance between the first geographic coordinate and the second geographic coordinate.

5. The system of claim 4, wherein, to flag, with the VPN/Proxy communication identifier application, the IP address based on the distance that is determined, the second electronic processor is further configured to
compare the difference in distance that is determined to a threshold, and
in response to determining the difference in distance is less than or equal to the threshold, flag the request as not received from the virtual private network.

6. The system of claim 4, wherein, to flag, with the VPN/Proxy communication identifier application, the IP address based on the distance that is determined, the second electronic processor is further configured to
compare the difference in distance that is determined to a threshold, and
in response to determining the difference in distance is greater than the threshold, flag the request as received from the virtual private network.

7. The system of claim 1, wherein the second electronic processor is further configured to
deny the request that is received based on the flagging of the request that is received.

8. The system of claim 1, wherein the second electronic processor is further configured to
transmit an indication to the client device based on the flagging of the request that is received, wherein the indication indicates denial of the request from the client device.

9. A method for identifying electronic communications from at least one of a virtual private network or proxy, the method comprising:
receiving, with an electronic processor, a request from a client device, wherein the request is enriched with location information of the client device,
determining, with the electronic processor, a geolocation of the client device based on the location information of the request that is enriched,
determining, with the electronic processor, a geolocation of an internet protocol (IP) address associated with the client device,
determining, with the electronic processor, a distance between the geolocation of the client device and the geolocation of the IP address, and
flagging, with the electronic processor, the request that is received as associated with a virtual private network or a proxy based on the distance that is determined.

10. The method of claim 9, further comprising:
defining, with the electronic processor, a threshold based on a source of the location information for the client device, wherein the location information includes geographic data related to a physical location of the client device.

11. The method of claim 9, wherein, determining, with the electronic processor, the geolocation of the IP address, the method further comprises:
extracting the IP address from the request, and
identifying a location associated with the IP address that is extracted.

12. The method of claim 9, wherein, determining, with the electronic processor, the distance between the geolocation of the client device and the geolocation of the IP address, method further comprises:
determining a first geographic coordinate for the geolocation of the client device and a second geographic coordinate for the geolocation of the IP address, and
determining a difference in distance between the first geographic coordinate and the second geographic coordinate.

13. The method of claim 12, wherein, flagging, with the electronic processor, the IP address based on the distance that is determined, the method further comprises:
comparing the difference in distance that is determined to a threshold, and
in response to determining the difference in distance is greater than the threshold, flagging the request as received from the virtual private network.

14. The method of claim 12, wherein, flagging, with the electronic processor, the IP address based on the distance that is determined, the method further comprises:
comparing the difference in distance that is determined to a threshold, and
in response to determining the difference in distance is less than or equal to the threshold, flagging the request as not received from the virtual private network.

15. A non-transitory computer-readable medium comprising instructions for identifying electronic communications from at least one of a virtual private network or proxy that, when executed by an electronic processor, cause the electronic processor to perform a set of operations comprising:
receiving a request from a client device, wherein the request is enriched with location information of the client device,
determining a geolocation of the client device based on the location information of the request that is enriched,
determining a geolocation of an internet protocol (IP) address associated with the client device,
determining, with the electronic processor, a distance between the geolocation of the client device and the geolocation of the IP address, and
flagging, with the electronic processor, the request that is received as associated with a virtual private network based on the distance that is determined.

16. The non-transitory computer-readable medium of claim 15, wherein, determining the geolocation of the client device, the further comprises:
retrieving, with an application interface of the client device, the location information for the client device, wherein the location information includes geographic data related to a physical location of the client device.

17. The non-transitory computer-readable medium of claim 15, further comprising:
defining a threshold based on a source of the location information for the client device.

18. The non-transitory computer-readable medium of claim 15, wherein, determining the geolocation of the IP address, the further comprises:
extracting the IP address from the request, and
identifying a location associated with the IP address that is extracted.

19. The non-transitory computer-readable medium of claim 15, wherein, determining the distance between the geolocation of the client device and the geolocation of the IP address, further comprises:
determining a first geographic coordinate for the geolocation of the client device and a second geographic coordinate for the geolocation of the IP address, and
determining a difference in distance between the first geographic coordinate and the second geographic coordinate.

20. The non-transitory computer-readable medium of claim 19, wherein, flagging the IP address based on the distance that is determined, the further comprises:
comparing the difference in distance that is determined to a threshold, and
in response to determining the difference in distance is greater than the threshold, flagging the as received from the virtual private network.

21. A method for identifying electronic communications from at least one of a virtual private network or proxy, the method comprising:
receiving, with an electronic processor, a first request of a client device with a first internet protocol (IP) address,
receiving, with the electronic processor, a subsequent request of the client device with a second IP address,
determining, with the electronic processor, a geographic distance between the first IP address and the second IP address, and
flagging, with the electronic processor, the client device as associated with a virtual private network or a proxy based on the geographic distance that is determined.
